(19) United States
(12) Patent Application Publication
(10) Pub. No.: US 2008/0024816 A1
(43) Pub. Date: Jan. 31, 2008

(54) Image forming apparatus having direct printing function and method of direct printing

(75) Inventor: Kyoung-jae Lee, Hwaseong-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/703,715

(22) Filed: Feb. 8, 2007

(30) Foreign Application Priority Data
Jul. 25, 2006 (KR) 2006-69724

(51) Int. Cl. G06F 3/12

(52) U.S. Cl. 358/1.15

(57) ABSTRACT

An image forming apparatus having a direct printing function and a method of direct printing. A communicator receives a signal to request a printing job of an image to be printed from an image providing apparatus. A storage unit stores a plurality of images having print histories of being printed. A controller determines whether the image to be printed is stored in the storage unit. If it is determined that the image to be printed is stored in the storage unit, the communicator informs the image providing apparatus that the printing job is completed and informs the image providing apparatus that the image providing apparatus does not need to transmit the image.

### CROSS-REFERENCE TO RELATED APPLICATIONS

This application claims the benefit under 35 U.S.C. §119(a) of Korean Patent Application No. 2006-69724, filed Jul. 25, 2006, the entire contents of which are incorporated herein by reference in their entirety.

### BACKGROUND OF THE INVENTION

1. Field of the Invention

The present general inventive concept relates to an image forming apparatus having a direct printing function and a method of direct printing. More particularly, the present general inventive concept relates to an image forming apparatus having a direct printing function and a method of direct printing using a pictbridge protocol to avoid having to repeatedly transmit an image from an image providing apparatus to enable multiple printing of the image on one or more sheetsby using (or re-using) an image (or image data) once transmitted.

2. Description of the Related Art

A pictbridge function refers to a function of directly transmitting an image (or image data) stored in a digital photographing apparatus (e.g., digital camera) to an image forming apparatus (e.g., printer) without the need to use a personal computer (PC) to print the image. Through the pictbridge function, a user may connect the digital photographing apparatus directly to the image forming apparatus using, for example, a universal serial bus (USB) cable, and select an image among a plurality of images (if more than one image is stored in the camera, for example) so as to quickly and easily print the selected image of the digital photographing apparatus.

However, conventionally, when the user requests the image forming apparatus to multiply print the same image (e.g., on a single or on a plurality of paper sheets or other suitable medium), the image forming apparatus requests (and receives transmission of) the same image over and over from the digital photographing apparatus for each time the image is re-printed. Such configuration is inconvenient because the digital photographing apparatus must remain connected to the image forming apparatus until image re-transmission of the last of the multiple printings is completed.

Thus, printing time is delayed, and protocol time related to the transmission and/or re-transmission of the image (e.g., from the camera) is unduly increased. In addition, the connection between the image forming apparatus and the digital photographing apparatus cannot be severed until the last printing (or last re-transmission of the image) is completed preventing further unencumbered use of the camera during such time. Thus, the user cannot use certain features and/or functions (e.g., taking further desired photographs) of the digital photographing apparatus while being connected to the image forming apparatus.

### SUMMARY OF THE INVENTION

The present general inventive concept provides an image forming apparatus having a direct printing function and a method of direct printing by which a pre-stored image can be accessed by the image forming apparatus after the image providing apparatus has transmitted the image (or image data) the first time so as to avoid having to re-transmit the identical image over and over to make multiple prints of the image and/or so as to reduce the time required to print the images and to minimize the time required to maintain a connection between the image forming apparatus and the image providing apparatus.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus having a direct printing function, including a communicator to receive a signal to request (or requesting and ultimately receiving) a printing job of an image (to be printed) from an image providing apparatus, a storage unit to store a plurality of images together with their print histories, and a controller to determine whether the image requested to be printed is already stored in the storage unit, so that if it is determined that the image to be printed is already stored in the storage unit, the communicator can inform the image providing apparatus that the image does not need to be transmitted by the image providing apparatus.

The image forming apparatus may further include a printing engine to conduct printing, such that if it is determined that the image to be printed is already stored in the storage unit, the controller can control the printing engine to print the stored image.

If, however, it is determined that the image to be printed is not already stored in the storage unit, the communicator may request a transmission of the image from the image providing apparatus and then receives the image from the image providing apparatus.

If multiple printings of the same image (on a single or on a plurality of paper sheets or other suitable medium) are requested by the image providing apparatus, the communicator may request and receive transmission of the image the first time and then the communicator does not request a re-transmission of the same image.

The communicator may communicate with the image providing apparatus with a pictbridge protocol.

The communicator may communicate with the image providing apparatus by a wired and/or wireless connection.

If the communicator communicates with the image providing apparatus by a wired connection, the communicator may be connected to the image providing apparatus through one of an Electrical and Electronic Engineers (IEEE) 1394 cable, a universal serial number (USB) cable, and a parallel cable.

If the communicator communicates with the image providing apparatus by a wireless connection, the image providing apparatus may transmit the image (to be printed) to the communicator with the use of an infrared communication (IrDA) method.

The image providing apparatus may be a digital photographing apparatus or equivalent. thereof.

The foregoing and/or other aspects and utilities of the present general inventive concept may also be achieved by providing a method of direct printing of an image by an image forming apparatus, including receiving a signal to request a printing job of an image to be printed from an image providing apparatus, determining whether the image (to be printed) is already pre-stored, and if it is determined that the image to be printed is pre-stored, informing the image providing apparatus that the printing job is completed and informing the image providing apparatus that the image providing apparatus does not need to transmit (or re-transmit) the image.

If the image to be printed is pre-stored, the method may further include printing the pre-stored image.

If it is determined that the image to be printed is not pre-stored, the method may further include requesting a transmission of the image from the image providing apparatus and receiving the transmission of the image from the image providing apparatus, printing the received image, and storing the received image.

If multiple printings of the image (on one or a plurality of paper sheets or other suitable medium) is requested from (or by) the image providing apparatus, the image (to be printed) may be received from the image providing apparatus, and then a re-transmission of the same image may not be requested of the image providing apparatus.

The foregoing and/or other aspects and utilities of the present general inventive concept may also be achieved by providing an image forming apparatus having a direct printing function, including an image forming apparatus having a direct printing function, including a controller to determine whether an image sought to be printed by the image forming apparatus has previously been stored in a storage memory of the image forming apparatus and to request a transmission of the image sought to be printed only if the image has not been previously stored in the storage memory.

The foregoing and/or other aspects and utilities of the present general inventive concept may also be achieved by providing an image forming apparatus having a direct printing function, including a communication port to receive an image sought to be printed together with a print request indicating how many copies of the image to print; a storage memory to store the image when received; a controller to determine whether the image has previously been stored in the storage memory, to store the image in the storage memory and to request a transmission of the image via the communication port only if the image has not been previously stored, and to inform via the communication port that the image has been printed once the transmission is completed or it is determined that the image has previously been stored in the storage memory; and a printing engine to print the image sought to be printed according to the print request.

The foregoing and/or other aspects and utilities of the present general inventive concept may also be achieved by providing a method of direct printing of an image sought to be printed, the method including requesting a transmission of the image only when it is determined that the image has not been previously stored in a printer storage memory; receiving the transmission only once if it is determined that the image has not been previously stored in the printer storage memory; and printing one or more copies of the image according to a printing request indicating how many copies of the image to print by using the image previously stored in the printer storage memory or using the transmitted the image.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a direct image printing system adopting an image forming apparatus having a direct printing function, according to an embodiment of the present general inventive concept;

FIG. 2 is a block diagram of the image forming apparatus illustrated in FIG. 1, according to an embodiment of the present general inventive concept;

FIG. 3 is a flowchart of a method of direct printing of the image by the image forming apparatus illustrated in FIG. 2, according to an embodiment of the present general inventive concept; and

FIG. 4 is a flowchart of a method of direct printing of the image by the image forming apparatus illustrated in FIG. 2, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

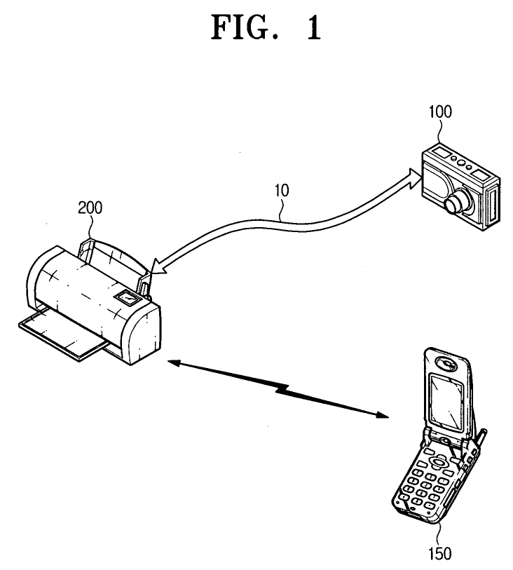

FIG. 1 is a view illustrating a direct image printing system adopting an image forming apparatus having a direct printing function, according to an embodiment of the present general inventive concept. Referring to FIG. 1, an image forming apparatus 200 having a direct printing function provides a pictbridge function. Thus, the image forming apparatus 200 is able to print an image directly transmitted to it from an image providing apparatus such as a digital photographing apparatus 100 or a mobile phone 150. Examples of the digital photographing apparatus 100 include a digital camera, a digital camcorder, etc., and examples of the mobile phone 150 include a personal digital assistant (PDA), a cellular phone, a personal communication services (PCS) phone, etc.

The image forming apparatus 200 communicates with the image providing apparatus by a wired and/or a wireless connection. For example, the image forming apparatus 200 receives an image from the digital photographing apparatus 100 using a pictbridge protocol and prints the image. Here, for example, the image is transmitted through a cable 10 such as a universal serial bus (USB) cable. Also, the image forming apparatus 200 can receive an image from the mobile phone 150 using the pictbridge protocol. Here, the mobile phone 150 can transmit the image to the image forming apparatus 200 via an infrared port by a wireless connection using an Infrared Data Association method (IrDA method). Other wireless connections may be used to transmit the image.

Also, if the digital photographing apparatus 100 supports the IrDA method, the digital photographing apparatus 100 may transmit an image by a wireless connection. If the mobile phone 150 includes a port into which the cable 10 is installed (or is connected into), the mobile phone 150 may transmit an image by a wired connection. Also, while the digital photographing apparatus 100 and the mobile phone 150 are illustratively used as examples to explain a pictbridge function and associated image transmission, all (or other) types of electronic devices capable of transmitting images, document data, etc. and supporting pictbridge communication may be adopted as image providing devices.

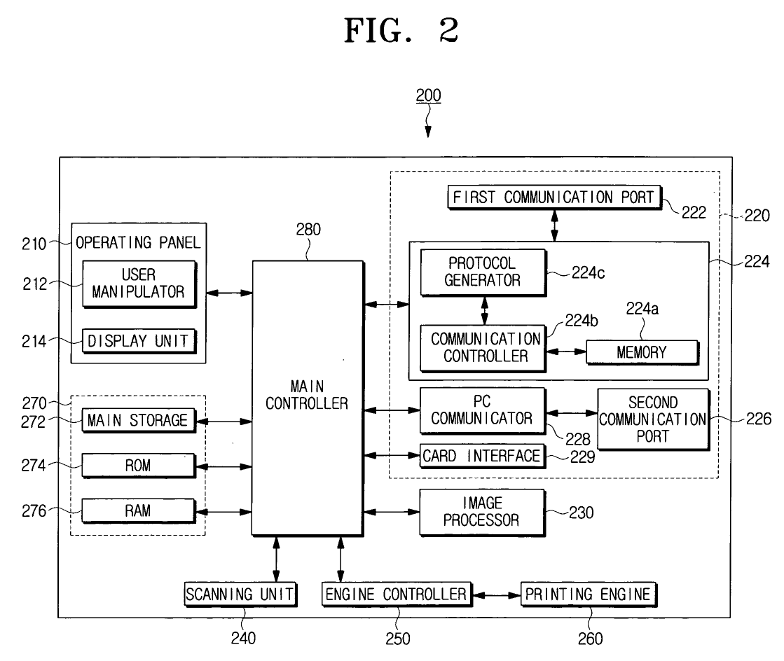

FIG. 2 is a block diagram of the image forming apparatus of FIG. 1, according to an embodiment of the present general inventive concept. Referring to FIGS. 1 and 2, the image forming apparatus 200 includes an operating panel 210, a communication interface 220, an image processor 230, a scanning unit 240, an engine controller 250, a printing engine 260, a storage unit 270, and a main controller 280.

The operating panel 210 includes a user manipulator 212 and a display unit 214 to support an interface between a user and the image forming apparatus 200. The user manipulator 212 outputs signals to select, manipulate, and/or request functions supported by the image forming apparatus 200 via the main controller 280. The user manipulator 212 can include various function keys and/or a touch screen. In particular, the user manipulator 212 outputs a selection signal to select one of an automatic storage mode and a selective storage mode. The automatic storage mode can be a mode in which an image transmitted from the digital photographing apparatus 100 is automatically stored. The selective storage mode can be a mode in which the image transmitted from the digital photographing apparatus 100 may be selectively stored by the user (e.g., according to the user's choice).

The user manipulator 212 can also set printing options of an image to be printed, e.g., a resolution, an aspect ratio, etc. The set printing options can be stored in a main storage 272.

The display unit 214 can be controlled by the main controller 280 to display a current status of the image forming apparatus 200, attribute information of a file which is currently being printed, etc. The display unit 214 may be realized as a liquid crystal display (LCD), a cathode ray tube (CRT), a plasma display unit panel (PDP), or the like.

The communication interface 220 can include a first communication port 222, a pictbridge communication module 224, a second communication port 226, a personal computer (PC) communicator 228, and a card interface 229.

The first communication port 222 is a port to which the cable 10 (see FIG. 1, for example) can be connected, to receive an image (to be printed) and/or a signal to request a printing job (of the image) from a device such as the digital photographing apparatus 100, and transmits (or provides) the image (to be printed) and/or a signal to the pictbridge communication module 224. Examples of the cable 10 include a USB cable, an Institute of Electrical and Electronic Engineers (IEEE) 1394 cable, a parallel cable, etc. Thus, the first communication port 222 can have an appropriate form (or configuration) matched to the type of the cable 10 used. While the first communication port 222 can be connected to the digital photographing apparatus 100 through the USB cable, other suitable connections may be used.

The pictbridge communication module 224 can communicate with (and/or transmit data to) an electronic communication device to support a pictbridge protocol, .e. g., the digital photographing apparatus 100. For this purpose, the pictbridge communication module 224 is electrically connected to the first communication port 222 and can include a memory 224a, a communication controller 224b, and a protocol generator 224c. Here, an interface (not illustrated) can be provided to guide various types of data input via the first communication port 222 to the main controller 280 or to the communication controller 224b.

The memory 224a can store a program to control and/or to manage communications that may be made using the pictbridge protocol.

The communication controller 224b can control the protocol generator 224c to analyze a protocol transmitted from the digital photographing apparatus 100 and to generate a protocol appropriate for a current status. In other words, if the signal to request the printing job is received from the digital photographing apparatus 100, the communication controller 224b can control the protocol generator 224c to generate a protocol to inform the digital photographing apparatus 100 that the printing job has started, that the printing of a first page (or a new page) has started, and/or that the printing job is completed. The communication controller 224b can also provide the image (to be printed and originally transmitted from the digital photographing apparatus 100, for example) to the engine controller 250 to print the image.

The communication controller 224b may request a transmission of the image to be printed just once even though the digital photographing apparatus 100 may have requested printing of a plurality of copies (or multiple printings) of the same image. Thus, repeated transmission of the same image to print a plurality of copies (or to make multiple printings) on one or more sheets (e.g., of paper or other suitable medium) may be avoided and the completion time of the printing of the plurality of copies (or multiple printings) is shortened.

The protocol generator 224c can generate various types of protocols necessary to communicate with the digital photographing apparatus 100 using a program that may be stored in the memory 224a. The various types of protocols generated may be transmitted to the photographing apparatus 100 through the first communication port 222 and the cable 10.

For example, if the cable 10 is connected to the digital photographing apparatus 100 and connected to the first communication port 222, and then a printing job request signal (to request printing of the image to be printed) is transmitted from the digital photographing apparatus 100, the protocol generator 224c may generate a first protocol and a second protocol. The first protocol may be used to inform the digital photographing apparatus 100 that the printing job has started. The second protocol may be used to inform the digital photographing apparatus 100 that actual printing, for example on a first paper sheet, has started. Suitable media other than the paper may be used to print multiple copies of the same image.

If the main controller 280 informs the protocol generator 224c of a determination that the image to be printed is pre-stored in the main storage 272 of the image forming apparatus 200, the protocol generator 224c can generate a third protocol to inform the digital photographing apparatus 100 that the printing job (of the image to be printed) has started or that the printing job is completed during or after printing of the image on a paper sheet (or other suitable medium). In other words, the image forming apparatus 200 informs the digital photographing apparatus 100 that the printing job is completed, without generating a protocol to request a transmission of the image to be printed.

Also, if the main controller 280 informs the protocol generator 224c that the image to be printed is pre-stored in the image forming apparatus 200, the protocol generator 224c can generate a fourth protocol to request a transmission (from the pre-stored location rather than from the digital photographing apparatus 100, for example) of the image to be printed.

The second communication port 226 can be connected to a PC through the cable 10 such as the USB cable and thus may be able to receive from the PC printing data of a document (written or stored) in the PC.

The PC communicator 228 can provide the printing data transmitted via the second communication port 226 ultimately to the engine controller 250. The PC communicator 228 may be a network interface card (NIC).

The card interface 229 can be an interface to a media card or to a hard disk drive (HDD). The media card (not illustrated) or the HDD (not illustrated) may be installed in the image forming apparatus 200 itself at the card interface 229, or may be able to communicate with the image forming apparatus 200 via card interface 229, for example. Thus, the main controller 280 may access and control a file structure stored in the media card or the HDD or read data from the media card or the HDD. Examples of the media card include a smart media card, a memory stick, a compact flash memory, etc.

If an image is read from the media card or the HDD installed in (and/or via) the card interface 229, the image processor 230 can transform (or processes) a resolution, a file format, etc. of the image into a new resolution, a new file format, etc. appropriate for use by the particular the image forming apparatus 200 utilized, if needed. The so processed image may be stored in the main storage 272, may be transmitted to the PC, and/or may be printed by the printing engine 260 according to a user request or choice.

The scanning unit 240 scans a document put on a document scanning screen (not illustrated) to generate a scanned image. A resolution, etc. of the scanned image may be adjusted by the image processor 230, and then the scanned image may be stored in the main storage 272 and/or printed by the printing engine 260, according to a user request or choice.

The engine controller 250 may be used to control and to drive the printing engine 260 to print the scanned image (or other image) using the printing data transmitted from the PC.

The printing engine 260 is driven by the engine controller 250 to form an image on a printing sheet such as paper (or other suitable medium). The printing engine 260 heats and pressurizes the printing sheet (or other suitable medium) at an appropriate temperature to fix and fuse an image onto the printing sheet (or other suitable medium) so as to perform (or execute) the printing job.

The storage unit 270 can include the main storage 272, a read only memory (ROM) 274, and a random access memory (RAM) 276.

The main storage 272 can store data received from external devices (and/or other devices), e.g., the digital photographing apparatus 100, the media card, the HDD, and the scanning unit 240. The main storage 272 can map and store an image transmitted from the digital photographing apparatus 100, identification (ID) information of the image, and ID information of the digital photographing apparatus 100. Here, the ID information of the digital photographing apparatus 100 may be stored for various reasons. For example, if one or more images photographed by a plurality of digital photographing devices (not illustrated in FIG. 2) have their respective ID information, the main storage 272 can easily identify the images stored in and/or received from those devices.

The ROM 274 can store various control programs necessary to utilize the function and operation of the image forming apparatus 200including one or more programs that may be necessary to communicate with or transfer data to/from the pictbridge communication module 224.

The RAM 276 can temporarily store various types of data generated during the operation of the image forming apparatus 200. For example, the RAM 276 can temporarily store attribute information of the image to be printed (transmitted from the digital photographing apparatus 100, for example).

The main controller 280 can control the operation of the image forming apparatus 200 using the stored control programs and inputs and outputs of signals between the above-described components.

In particular, if the digital photographing apparatus 100 is connected to the first communication port 222 through the cable 10, and then the attribute information of the image (to be printed) and the printing job request signal are transmitted from the digital photographing apparatus 100, the main controller 280 can control the RAM 276 to temporarily store the attribute information of the image (to be printed). Here, the attribute information can include the ID information of the image to be printed and the ID information of the digital photographing apparatus 100. Also, the main controller 280 can determine whether attribute information equal to the attribute information temporarily stored in the RAM 276 is already stored in the main storage 272 and can output the determination result to the communication controller 224b of the pictbridge communication module 224.

If it is determined that the attribute information equal to the attribute information temporarily stored in the RAM 276 is already stored in the main storage 272, the main controller 280 reads an image (having the attribute information) from the main storage 272, provides the image to the engine controller 250, and controls the engine controller 250 to print the image. Thus, the engine controller 250 controls the printing engine 260 to print the selected image according to set printing options. Also, the communication controller 224b does not request the transmission (of the image to be printed) from the digital photographing apparatus 100. Thus, for example, the communication controller 224b controls the protocol generator 224c to generate the third protocol to inform the digital photographing apparatus 100 that the printing job is completed and to inform the digital photographing apparatus 100 that the digital photographing apparatus 100 does not need to transmit the image (to be printed).

If it is determined that the attribute information equal to the attribute information temporarily stored in the RAM 276 is not already stored in the main storage 272, the communication controller 224b determines that the image (to be printed) is not stored in the main storage 272 and thus controls the protocol generator 224c to generate the fourth protocol to request the transmission of the image (to be printed). If the image (to be printed) is transmitted from the digital photographing apparatus 100, the main controller 280 controls the engine controller 250 to print the image.

Additionally, the main controller 280 can control storage of a new image transmitted from the digital photographing apparatus 100, i.e., a storage of an image which is not stored in the main storage 272, according to a mode set in the image forming apparatus 200. For example, if an image transmitted from the digital photographing apparatus 100 is a new image and the mode of the image forming apparatus 200 is set to the automatic storage mode, the main controller 280 controls the main storage 272 to store the new image, ID information of the new image, and the ID information of the digital photographing apparatus 100 which transmitted the new image.

If the mode of the image forming apparatus 200 is set to the selective storage mode, the main controller 280 generates a display message (or other such indicator) requesting whether the user wants to store the new image and then controls the display unit 214 to display the message. If the user elects to store the new image (via the user manipulator 212, for example), the main controller 280 controls the main storage 272 to store the new image, the ID information of the new image, and the ID information of the digital photographing apparatus 100 which transmitted the new image. If the user elects not to store the new image (via the user manipulator 212, for example), the main controller 280 temporarily stores the new image in the RAM 276. After the printing job is completed, the main controller 280 deletes the image, which was temporarily stored in the RAM 276.

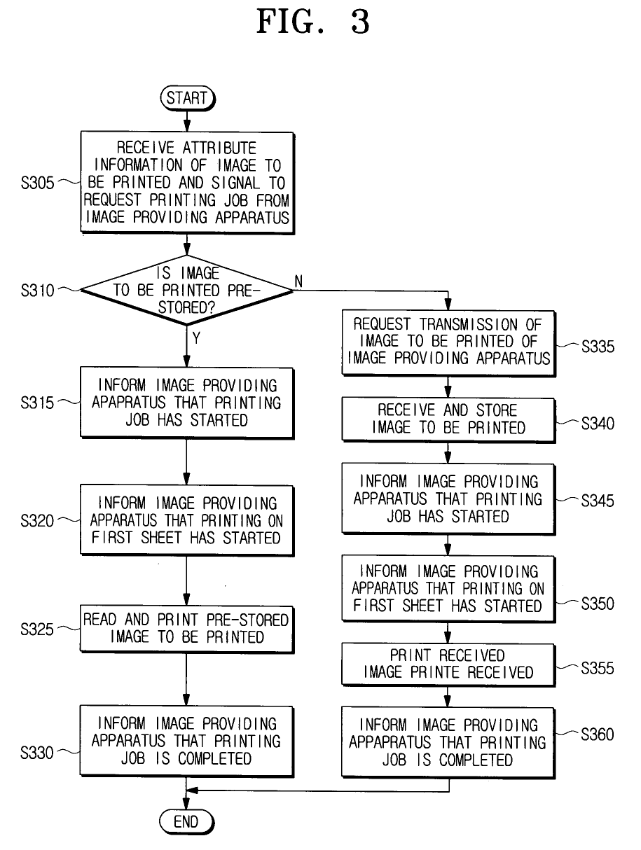

FIG. 3 is a flowchart of a method of direct printing of the image forming apparatus 200 illustrated in FIG. 2, according to an embodiment of the present general inventive concept. Referring to the embodiments of FIGS. 1 through 3 of the present general inventive concept, if attribute information of an image to be printed and a signal to request a printing job are received from an image providing apparatus connected to the first communication port 222 through the cable 10, i.e., from the digital photographing apparatus 100 in operation S305, the communication controller 224b outputs the attribute information to the main controller 280 through an interface such as a bus (not illustrated).

In operation S310, the main controller 280 temporarily stores the attribute information of the image (to be printed) in the RAM 276 and then checks whether the temporarily stored attribute information is pre-stored in the main storage 272 to determine whether the image (to be printed) is pre-stored.

If it is determined in operation S310 that the attribute information of the image (to be printed) is pre-stored in the main storage 272, the main controller 280 determines that the image to be printed is pre-stored and outputs the determination result to the communication controller 224b. In operation S315, the communication controller 224b then controls the protocol generator 224c to generate a first protocol to inform the digital photographing apparatus 100 that the printing job has started, and the first communication port 222 transmits the first protocol to the digital photographing apparatus 100.

In operation S320, the communication controller 224b controls the protocol generator 224c to generate a second protocol to inform the digital photographing apparatus 100 that printing of the image on a first paper sheet has started, and the first communication port 222 transmits the second protocol to the digital photographing apparatus 100.

In operation S325, the main controller 280 reads the pre-stored image corresponding to the received attribute information from the image storage 272, transmits the image to the engine controller 250, and controls the engine controller 250 to print the transmitted image. Thus, the engine controller 250 controls the printing engine 260 to be driven so as to print the read image according to pre-set printing options.

In operation S330, the communication controller 224b controls the protocol generator 224c to generate a third protocol to inform the digital photographing apparatus 100 that the printing job is completed, and the first communication port 222 transmits the third protocol to the digital photographing apparatus 100. Thus, the digital photographing apparatus 100 does not transmit the image (to be printed) to the image forming apparatus 200. Operation S330 may be performed before or during the performance of operation S325.

If it is determined in operation S310 that the attribute information of the image (to be printed) is not pre-stored in the main storage 272, the main controller 280 determines that the image (to be printed) is not stored and outputs the determination result to the communication controller 224b. In operation S335, the communication controller 224b controls the protocol generator 224c to generate a fourth protocol to request a transmission of the image (to be printed), and the first communication port 222 is controlled by the main controller 280 to transmit the fourth protocol to the digital photographing apparatus 100.

In operation S340, the communication controller 224b receives the image (to be printed) from the digital photographing apparatus 100 and provides the image to the main controller 280, and the main controller 280 controls the main storage 272 to store the image to be printed. The image transmitted from the digital photographing apparatus 100 in operation S340 includes attribute information thereof and attribute information of the digital photographing apparatus 100. Thus, the main storage 272 maps and stores the image to be printed, the attribute information of the image, and the attribute information of the digital photographing apparatus 100.

In operation S345, the communication controller 224b controls the protocol generator 224c to generate the first protocol for informing the digital photographing apparatus 100 that the printing job has started, and the first communication port 222 is controlled by the main controller 280 to transmit the first protocol to the digital photographing apparatus 100.

In operation S350, the communication controller 224b controls the protocol generator 224c to generate the second protocol to inform the digital photographing apparatus 100 that printing of the image on the first sheet has started, and the first communication port 222 is controlled by the main controller 280 to transmit the second protocol to the digital photographing apparatus 100.

In operation S355, the main controller 280 controls the engine controller 250 to print the image stored in operation S340. Thus, the engine controller 250 controls the printing engine 260 to be driven so as to print the image according to the pre-set printing options.

In operation S360, the communication controller 224b controls the protocol generator 224c to generate the third protocol to inform the digital photographing apparatus 100 that the printing job is completed, and the first communication port 222 transmits the third protocol to the digital photographing apparatus 100. Even if printing of the image on a plurality of (e.g., paper) sheets is requested in operation S305, the communication controller 224b receives the image only once and then performs operation S355, as many times as needed. As a result, the digital photographing apparatus 100 does not re-transmit the image to be printed to the image forming apparatus 200. Here, operation S360 may be performed before or during the performance of operation S355.

According to an embodiment of the present general inventive concept, the image forming apparatus 200 checks whether the image to be printed is pre-stored, and if the image is pre-stored, the image forming apparatus 200 informs the digital photographing apparatus 100 that the printing job has started and is completed, and also executes the printing job. Also, if the image is not pre-stored, the image forming apparatus 200 receives the image to be printed from the digital photographing apparatus 100, stores the image, informs the digital photographing apparatus 100 that the printing job has started and is completed, and also executes the printing job.

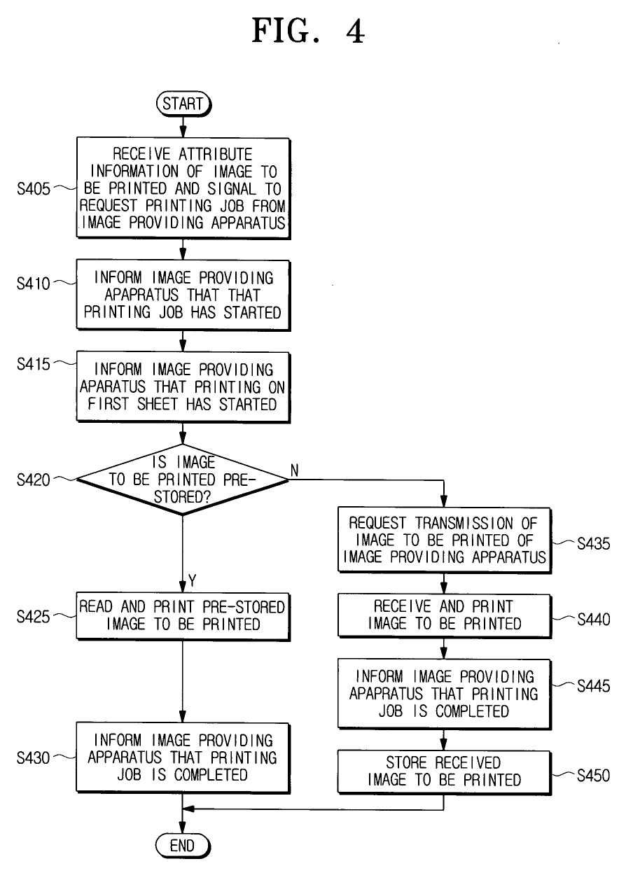

FIG. 4 is a flowchart of a method of direct printing of the image forming apparatus illustrated in FIG. 2, according to an embodiment of the present general inventive concept. Referring to FIGS. 1, 2, and 4, in operation S405, attribute information of an image (to be printed) and a signal to request a printing job are received from an image providing apparatus connected to the first communication port 222 through the cable 10, i.e., the digital photographing apparatus 100. In operation S410, the communication controller 224b controls the protocol generator 224c to generate a first protocol to inform the digital photographing apparatus 100 that the printing job has started, and the first communication port 222 transmits the first protocol to the digital photographing apparatus 100. Also, in operation S405, the communication controller 224b outputs the attribute information to the main controller 280 through an interface such as a bus (not illustrated).

In operation S415, the communication controller 224b controls the protocol generator 224c to generate a second protocol to inform the digital photographing apparatus 100 that printing of the image on a first (e.g., paper) sheet has started, and the first communication port 222 transmits the second protocol to the digital photographing apparatus 100.

In operation S420, the main controller 280 temporarily stores the attribute information of the image received in operation S405 in the RAM 276 and then checks whether the temporarily stored attribute information is pre-stored in the main storage 272 to determine whether the image to be printed is pre-stored.

If it is determined in operation S420 that the attribute information of the image to be printed is pre-stored in the main storage 272, then in operation S425 the main controller 280 reads the pre-stored image corresponding to the attribute information from the main storage 272, transmits the read image to the engine controller 250, and controls the engine controller 250 to print the transmitted image. The engine controller 250 controls the printing engine 260 to be driven so as to print the read image according to pre-set printing options.

In operation S430, the communication controller 224b controls the protocol generator 224c to generate a third protocol to inform the digital photographing apparatus 100 that the printing job is completed, and the first communication port 222 transmits the third protocol to the digital photographing apparatus 100. Thus, the digital photographing apparatus 100 does not transmit the image (to be printed) to the image forming apparatus 200. Here, operation S430 may be performed before or during the performance of operation S425.

If it is determined in operation S420 that the attribute information of the image (to be printed) is not pre-stored in the main storage 272, the main controller 280 determines that the image (to be printed) is not stored and outputs the determination result to the communication controller 224b. In operation S435, the communication controller 224b controls the protocol generator 224c to generate a fourth protocol to request a transmission of the image to be printed, and the first communication port 222 is controlled by the main controller 280 to transmit the fourth protocol to the digital photographing apparatus 100.

In operation S440, the communication controller 224b receives the image (to be printed) from the digital photographing apparatus 100 and provides the image to the main controller 280, and the main controller 280 controls the engine controller 250 to print the received image.

In operation S445, the communication controller 224b controls the protocol generator 224c to generate the third protocol to inform the digital photographing apparatus 100 that the printing job is completed, and the first communication port 222 transmits the third protocol to the digital photographing apparatus 100. Even if printing of the image on a plurality of (e.g., paper or other suitable medium) sheets (or multiple printings on a single sheet) is requested in operation S405, the communication controller 224b receives the image only once and then multiply prints the image as needed in operation S440. Thus, the digital photographing apparatus 100 does not re-transmit the image (to be printed) to the image forming apparatus 200. Here, operation S445 may be performed before or during the performance of operation S440.

In operation S450, the main controller 280 controls the main storage 272 to store the received image to be printed. The image transmitted from the digital photographing apparatus 100 includes the attribute information thereof and attribute information of the digital photographing apparatus 100. Thus, the main storage 272 maps and stores the image (to be printed), the attribute information of the image, and the attribute information of the digital photographing apparatus 100 in operation S450.

According to an embodiment of the present general inventive concept, the image forming apparatus 200 informs the digital photographing apparatus 100 that the printing job has started and then checks whether the image to be printed is pre-stored. If the image is pre-stored, the image forming apparatus 200 informs the digital photographing apparatus 100 that the printing job is completed and executes the printing job. If the image is not pre-stored, the image forming apparatus 200 receives the image (to be printed) from the digital photographing apparatus 100, stores the image, informs the digital photographing apparatus 10 that the printing job has started and is completed, and executes the printing job.

Also, according to the above-described embodiments of the present general inventive concept, the image forming apparatus 200 may print the same image on a plurality of paper (or other) sheets at a time or may print the image on the plurality of paper (or other) sheets at predetermined time intervals. Thus, if the image to be printed has a history of being previously printed, the image forming apparatus 200 may readily print the image without re-receiving the image from the digital photographing apparatus 100.

While certain embodiments of the present general inventive concept have been described with reference to the digital photographing apparatus 100 being connected via the cable 10, other types of devices such as the mobile phone 150 supporting a pictbridge protocol may be used connected via the cable 10.

Also, while data such as the above-described protocols and the image to be printed may be transmitted and/or received through the cable 10, the same may be accomplished by a wireless connecting using an infrared communication method.

In addition, the mode of the image forming apparatus 200 may be set to the automatic storage mode or selective storage mode. Thus, if the mode of the image forming apparatus 200 is set to the selective storage mode, the above-described message (requesting user input whether to store the image) may be displayed on the display unit 214 before the image to be printed is stored (if the user elects to store the image).

As described above, in an image forming apparatus having a direct printing function (and a method of direct printing) according to an embodiment of the present general inventive concept, if printing of a previously printed image is requested from an image providing apparatus, a pre-stored image can be printed without re-receiving the image from the image providing apparatus. Thus, the time required to transmit a protocol related to a transmission of the image and the time required to process the image can be reduced, and a load on a system (to do same) can be relieved.

Also, before printing of the image is completed (as many times as requested) by the image providing apparatus, a connection between the image forming apparatus and the image providing apparatus can be ended. Thus, the image providing apparatus does not need to maintain the connection with the image forming apparatus until all the printing is completed. As a result, a user can use other functions of the image providing apparatus even while the printing job is being executed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus having a direct printing function, comprising:
a communicator to receive a signal to request a printing job of an image to be printed from an image providing apparatus;
a storage unit to store a plurality of images having print histories of being printed; and
a controller to determine whether the image to be printed is stored in the storage unit,
wherein if it is determined that the image to be printed is stored in the storage unit, the communicator informs the image providing apparatus that the printing job is completed and informs the image providing apparatus that the image providing apparatus does not need to transmit the image sought to be printed.

2. The image forming apparatus of claim 1, further comprising a printing engine to perform printing,
wherein if it is determined that the image to be printed is stored in the storage unit, the controller controls the printing engine to print the stored image.

3. The image forming apparatus of claim 1, wherein if it is determined that the image to be printed is not stored in the storage unit, the communicator requests a transmission of the image from the image providing apparatus and receives the image from the image providing apparatus.

4. The image forming apparatus of claim 3, wherein if multiple printing of the image is requested from the image providing apparatus, the communicator receives transmission of the image only once and then does not request a re-transmission of the image.

5. The image forming apparatus of claim 1, wherein the communicator communicates with the image providing apparatus using a pictbridge protocol.

6. The image forming apparatus of claim 1, wherein the communicator communicates with the image providing apparatus by a wired or a wireless connection.

7. The image forming apparatus of claim 6, wherein if the communicator communicates with the image providing apparatus by the wired connection, the communicator is connected to the image providing apparatus through one of an IEEE (Electrical and Electronic Engineers) 1394 cable, a USB (universal serial number) cable, and a parallel cable.

8. The image forming apparatus of claim 6, wherein if the communicator communicates with the image providing apparatus by the wireless connection, the image providing apparatus transmits the image to be printed to the communicator using an IrDA (Infrared Data Association) method.

9. The image forming apparatus of claim 1, wherein the image providing apparatus is a digital photographing apparatus.

10. A method for direct printing of an image forming apparatus, comprising:
receiving a signal to request a printing job of an image to be printed from an image providing apparatus;
determining whether the image to be printed is pre-stored; and
if it is determined that the image to be printed is pre-stored, informing the image providing apparatus that the printing job is completed and informing the image providing apparatus that the image providing apparatus does not need to transmit the image.

11. The method of claim 10, if the image to be printed is pre-stored, further comprising printing the pre-stored image.

12. The method of claim 10, if it is determined that the image to be printed is not pre-stored, further comprising:
requesting a transmission of the image from the image providing apparatus; receiving the image from the image providing apparatus;
printing the received image; and
storing the received image.

13. The method of claim 12, wherein if multiple printing of the image is requested from the image providing apparatus, then not requesting a re-transmission of the image from the image providing apparatus.

14. The method of claim 10, wherein the image forming apparatus communicates with the image providing apparatus using a pictbridge protocol.

15. The method of claim 10, wherein the image forming apparatus communicates with the image providing apparatus by a wired or a wireless connection.

16. The method of claim 10, wherein the image providing apparatus is a digital photographing apparatus.

17. An image forming apparatus having a direct printing function, comprising:
a controller to determine whether an image sought to be printed by the image forming apparatus has previously been stored in a storage memory of the image forming apparatus and to request a transmission of the image sought to be printed only if the image has not been previously stored in the storage memory.

18. An image forming apparatus having a direct printing function, comprising:
a communication port to receive an image sought to be printed together with a print request indicating how many copies of the image to print; a storage memory to store the image when received;
a controller to determine whether the image has previously been stored in the storage memory, to store the image in the storage memory and to request a transmission of the image via the communication port only if the image has not been previously stored, and to inform via the communication port that the image has been printed once the transmission is completed or it is determined that the image has previously been stored in the storage memory; and
a printing engine to print the image sought to be printed according to the print request.

19. A method of direct printing of an image sought to be printed, the method comprising:
requesting a transmission of the image only when it is determined that the image has not been previously stored in a printer storage memory;
receiving the transmission only once if it is determined that the image has not been previously stored in the printer storage memory; and
printing one or more copies of the image according to a printing request indicating how many copies of the image to print by using the image previously stored in the printer storage memory or using the transmitted the image.
